(19) United States
(12) Patent Application Publication
(10) Pub. No.: US 2018/0033427 A1
(43) Pub. Date: Feb. 1, 2018

(54) SPEECH RECOGNITION TRANSFORMATION SYSTEM

(71) Applicant: Samsung Electronics Co., Ltd., Suwon-si (KR)

(72) Inventor: Nam Yeong KWON, Suwon-si (KR)

(73) Assignee: Samsung Electronics Co., Ltd., Suwon-si (KR)

(21) Appl. No.: 15/472,623

(22) Filed: Mar. 29, 2017

(30) Foreign Application Priority Data
Jul. 27, 2016 (KR) 10-2016-0095735

(51) Int. Cl. G10L 15/06; G10L 15/02; G10L 15/18; G10L 15/00

(52) U.S. Cl. CPC G10L 15/063; G10L 15/005; G10L 15/02; G10L 15/18; G10L 2015/025

(57) ABSTRACT

A speech recognition method may include preprocessing a first signal to generate a second signal, where the first signal corresponds to an audio signal that includes at least one voice audio signal generated by a speaker, extracting a feature point associated with the second signal and converting the second signal into a third signal by converting the feature point using a transformation model, applying a recognition model to the third signal to recognize a voice language corresponding to the at least one voice audio signal; and generating a recognition result output including information indicating the recognized language.

### CROSS-REFERENCE TO RELATED APPLICATIONS

This application claims benefit of priority under 35 U.S.C. § 119 to Korean Patent Application No. 10-2016-0095735 filed on Jul. 27, 2016 in the Korean Intellectual Property Office, the disclosure of which is incorporated herein by reference in its entirety.

### BACKGROUND

### 1. Field

The present inventive concepts relate to speech recognition methods, speech recognition devices, apparatuses including one or more speech recognition devices, non-transitory storage media storing one or more computer-executable programs associated with speech recognition functionality, and methods of generating one or more transformation models, in which speech may be effectively recognized.

2. Description of Related Art

Speech recognition has been widely used in various types of mobile terminal electronic devices, such as smartphones and the like, smart television sets, refrigerators, and the like. To improve the accuracy of speech recognition, one or more various preprocessing techniques (also referred to herein as preprocessing operations) may be applied (“performed”) to audio signals input (“received”) from one or more microphones. A preprocessing technique is a technique that, when performed, enables a recognized sound (e.g., recognized signal) in an audio signal to become clearer through an operation of removing signals corresponding to noise (e.g., background noise, ambient noise, white noise, etc.) and the like from audio signals input through microphones. For example, a preprocessing technique may include operations of removing ambient noise from an audio signal input through a microphone and removing signals determined to correspond to speech of other speakers (e.g., voice audio signals generated by one or more “other” speakers), except for speech of a speaker to be recognized (e.g., voice audio signals generated by a particular speaker). Since a variety of devices to which speech recognition is applied have different service environments, preprocessing techniques appropriate thereto are applied to respective devices.

### SUMMARY

Some aspects of the present inventive concepts include providing a speech recognition method of effectively recognizing speech.

Some aspects of the present inventive concepts is to provide a speech recognition device in which speech may be effectively recognized.

Some aspects of the present inventive concepts include providing an apparatus including a speech recognition device in which speech may be effectively recognized.

Some aspects of the present inventive concepts include providing a storage medium storing a program for an effective speech recognition method.

Some aspects of the present inventive concepts include providing a method of generating a transformation model allowing a speech recognition device to be more effectively recognize speech.

According to some example embodiments, a method may include: performing a preprocessing operation on a first signal to generate a second signal, the first signal corresponding to an audio signal that includes at least one voice audio signal generated by a speaker; extracting a feature point associated with the second signal; converting the second signal into a third signal based on converting the feature point using a transformation model; applying a recognition model to the third signal to recognize a voice language corresponding to the at least one voice audio signal; and generating a recognition result output including information indicating the recognized language.

According to some example embodiments, a speech recognition device may include: a microphone configured to generate a first signal based on receiving an audio signal that includes at least one voice audio signal generated by a speaker; a memory storing a program of instructions associated with speech recognition; and a processor configured to execute the program of instructions to: perform a preprocessing operation on the first signal to generate a second signal; extract a feature point associated with the second signal; convert the second signal into a third signal based on converting the feature point using a transformation model; applying a recognition model to the third signal to recognize a voice language corresponding to the at least one voice audio signal; and generate a recognition result output including information indicating the recognized language.

According to some example embodiments, an apparatus may include: a microphone configured to generate a first signal based on receiving an audio signal that includes at least one voice audio signal generated by a speaker; a memory storing a program of instructions associated with speech recognition; and a processor configured to execute the program of instructions to: perform a preprocessing operation on the first signal to generate a second signal, extract a feature point associated with the second signal, convert the second signal into a third signal based on converting the feature point using a transformation model, and recognizing speech corresponding to the at least one voice audio signal based on applying a recognition model to the third signal.

According to some example embodiments, an apparatus may include: a microphone configured to generate a first signal based on receiving an audio signal that includes at least one voice audio signal generated by a speaker; a memory storing a program of instructions associated with speech recognition; and a processor configured to execute the program of instructions to: perform a preprocessing operation on the first signal to generate a second signal, convert the second signal into a third signal using a transformation model, and recognize speech included in the at least one voice audio signal based on applying a recognition model to the third signal. The transformation model may be generated based on: generating a transformation database audio signal having signal characteristics that are substantially common with signal characteristics of a speech learning signal associated with the recognition model, generating a first conversion signal corresponding to one or more voice audio signals included in the transformation database audio signal, generating a preprocessing transformation database based on performing the preprocessing operation on the first conversion signal, and performing model training according to the preprocessing transformation database to generate the transformation model.

According to some example embodiments, an apparatus may include: a microphone configured to generate a first signal based on receiving an audio signal that includes at least one voice audio signal generated by a speaker, and generate a second signal based on performing a preprocessing operation on the first signal; a memory storing a program of instructions associated with speech recognition; and a processor configured to execute the program of instructions to extract a feature point associated with the second signal, convert the second signal into a third signal based on converting the feature point using a transformation model, and recognizing speech included in the at least one voice audio signal based on applying a recognition model to the third signal.

According to some example embodiments, an apparatus may include: a microphone configured to generate a first signal based on receiving an audio signal that includes at least one voice audio signal generated by a speaker; a memory storing a program of instructions associated with speech recognition; a processor configured to execute the program of instructions to perform a preprocessing operation on the first signal to generate a second signal, extract a feature point associated with the second signal, and convert the second signal into a third signal based on converting the feature point using a transformation model; and a communications interface configured to transmit the third signal.

According to some example embodiments, an apparatus may include: a communications interface configured to receive a first signal, the first signal corresponding to an audio signal that includes at least one voice audio signal generated by a speaker; a memory storing a program of instructions; and a processor. The processor may be configured to execute the program of instructions to extract a feature point associated with the first signal, convert the first signal into a second signal based on converting the feature point using a transformation model, and recognize speech included in the at least one audio signal based on applying a recognition model to the second signal.

According to some example embodiments, an apparatus may include: a communications interface configured to receive a first signal, the first signal corresponding to an audio signal that includes at least one voice audio signal generated by a speaker; a memory storing a program of instructions; and a processor. The processor may be configured to execute the program of instructions to convert the first signal into a second signal using a transformation model and recognizing speech by applying a recognition model to the second signal, wherein the transformation model is generated based on: playing a transformation database signal having common signal characteristics with a speech learning signal used in learning the recognition model, generating a first conversion signal corresponding to speech generated by operation of playing, via a microphone, generating a preprocessing transformation database by performing a preprocessing operation on the first conversion signal, and performing model training using the preprocessing transformation database.

According to some example embodiments, a storage medium may include a program written to perform, by a processor, a method. The method may include: preprocessing a first signal to generate a second signal, the first signal corresponding to an audio signal that includes at least one voice audio signal generated by a speaker; extracting a feature point associated with the second signal and converting the second signal into a third signal by converting the feature point using a transformation model; applying a recognition model to the third signal to recognize a voice language corresponding to the at least one voice audio signal; and generating a recognition result output including information indicating the recognized language.

According to some example embodiments, a method may include: playing a transformation database audio signal having signal characteristics that are substantially common with signal characteristics of a speech learning signal associated with a recognition model; generating a first conversion signal corresponding to one or more voice audio signals included in the one or more audio signals; generating a preprocessing transformation database based on performing a preprocessing operation on the first conversion signal; and performing model training according to the preprocessing transformation database to generate a transformation model.

According to some example embodiments, a method may include: extracting, from a signal, a feature point associated with the signal, the signal corresponding to an audio signal that includes at least one voice audio signal generated by a speaker; converting the signal based on converting the feature point using a transformation model; applying a recognition model to the converted signal to recognize a voice language corresponding to the at least one voice audio signal; and generating a recognition result output including information indicating the recognized language.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a schematic block diagram of a speech recognition device according to some example embodiments of the present inventive concepts;

FIG. 2 is a drawing illustrating a process of learning a recognition model of a speech recognition device according to some example embodiments of the present inventive concepts;

FIG. 3 is a drawing illustrating a process of learning a transformation model of a speech recognition device according to some example embodiments of the present inventive concepts;

FIG. 4 is a drawing illustrating operations of a conversion portion of a speech recognition device according to some example embodiments of the present inventive concepts;

FIG. 5 is a flowchart illustrating operations of a speech recognition method according to some example embodiments of the present inventive concepts;

FIG. 6 is a flowchart illustrating transformation operations of the speech recognition method of FIG. 5;

FIG. 7 is a flowchart illustrating recognition operations of the speech recognition method of FIG. 5;

FIG. 8, FIG. 9, and FIG. 10 are schematic diagrams of apparatuses including a speech recognition device according to some example embodiments of the present inventive concepts;

FIG. 11 is a schematic diagram illustrating a system in which a speech recognition method according to some example embodiments of the present inventive concepts is performed; and

FIG. 12 is a view conceptually illustrating a method of applying a speech recognition method according to some example embodiments of the present inventive concepts to a variety of devices.

### DETAILED DESCRIPTION

Hereinafter, example embodiments of the present inventive concepts will be described with reference to the accompanying drawings.

The terms “-unit/portion”, “-engine”, “-model”, “-module”, “system”, “constituent element”, “interface”, and the like, used herein, normally refer to hardware, a combination of hardware and software, software, or a computer-related entity which is software in execution. For example, “-unit” may be a process at least partially implemented by at least one processor, a processor, an object, an executable subject, execution thread, a program of instructions that may be executed by a processor, and/or a computer, but is not limited thereto. For example, all applications and controllers running on the controller may be constituent elements. One or more components may be present in a process and/or thread of execution, the constituent elements may be localized on one computer, or may be distributed between two or more computers.

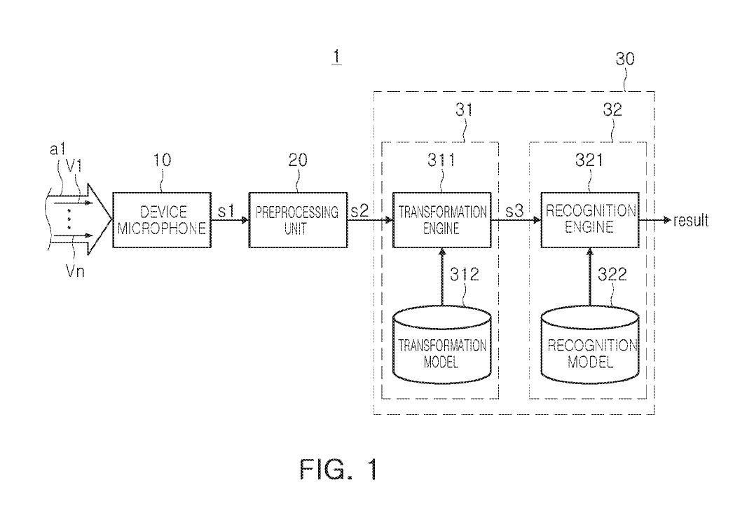

FIG. 1 is a schematic block diagram of a speech recognition device according to some example embodiments. A speech recognition device 1 according to some example embodiments may include a device microphone 10, a preprocessor 20, and a speech recognition unit 30. The speech recognition unit 30 may include a conversion portion 31 and a recognition portion 32. The conversion portion 31 may include a transformation engine 311 and a transformation model 312, and the recognition portion 32 may include a recognition engine 321 and a recognition model 322. One or more of the preprocessor 20 and the speech recognition unit 30 may be at least partially implemented by one or more processors executing at least one program of instructions stored at one or more memory devices (also referred to herein as one or more memories).

The device microphone 10 may output a first signal s1 corresponding to input speech a1 (also referred to herein as an audio signal a1, received at the device microphone 10, that includes at least one voice audio signal v1 generated by at least one speaker). The first signal s1 may be an electronic signal generated by the device microphone 10 based on the audio signal a1, such that the first signal s1 corresponds to the audio signal a1.

The preprocessor 20 may receive the first signal s1 and perform a preprocessing operation thereon to output (“generate”) a second signal s2. The preprocessing operation may be an operation allowing the at least one voice audio signal v1 in the first signal s1 to be recognized more clearly. The preprocessor 20 may perform appropriate preprocessing operations according to a type of device or other factors of an apparatus to which the speech recognition device is applied. For example, when the speech recognition device is a television set, the preprocessor 20 may perform an operation of removing a signal corresponding to sound output from a speaker of the television set, from the first signal s1 input from the device microphone 10, for example, performing acoustic echo cancellation (AEC) as a preprocessing operation. In some example embodiments, the preprocessor 20 may perform, as a preprocessing operation, one or more of an operation of removing speech of other speakers (e.g., removing a portion of the first signal s1 that corresponds to one or more audio signals v2 to vn generated by one or more “other” speakers, where “n” is a positive integer), except for speech of a specific speaker (e.g., a portion of the first signal s1 that corresponds to audio signal v1), for example, blind source extraction (BSE), an operation of adjusting a magnitude of the first signal s1 to an appropriate magnitude thereof, for example, dynamic range compression (DRC), an operation of detecting a point in time that speech is actually started and then removing a signal provided before the point in time, for example, voice activity detection (VAD), or a simple operation to remove of noise.

The preprocessing operation may be performed by software or may also be performed by hardware. In addition, the preprocessor 20 may be implemented as a separate unit, may be included in the device microphone 10, or may also be included in the speech recognition unit 30. In some example embodiments, the preprocessor 20 may be classified into respective constituent elements according to functions thereof, and respective separated constituent elements may be included in the device microphone 10 and the speech recognition unit 30.

The speech recognition unit 30 may recognize speech using a recognition model 322, by converting the second signal s2 into a third signal s3 having signal characteristics similar to (e.g., common with) those of a signal used when learning the recognition model 322, and then applying the recognition model 322 to the third signal s3, and outputting a recognition result. For example, the speech recognition unit 30 may extract, from the third signal s3, a feature point associated with the third signal s3, apply the feature point to the recognition model 322, and output information indicating a recognition result based on the applied result.

The conversion portion 31 may change a feature point associated with the second signal s2 to thus convert the second signal s2 into the third signal s3 having signal characteristics similar to those of a signal used when learning the recognition model 322. In some example embodiments, similar (e.g., common) signal characteristics of two signals may indicate that the feature points associated with two signals in which syllables, words, or phrases are the same as each other, are similar to each other. In this case, the feature points associated with two signals, for example, values associated with one or more frequency characteristics, phases, or the like, are extracted for recognition of speech. In more detail, after dividing signals based on a standard unit of time, when a difference between values of frequencies associated with the divided signals, for example, the magnitude or energy of respective frequencies provided when converting signals into frequency domains, is within a desired (or, alternatively predetermined) error range, the characteristics of signals may be determined as being similar to each other.

The transformation engine 311 may extract a feature point associated with the second signal s2 and change the feature point associated with the second signal s2 using the transformation model 312, thereby converting the second signal s2 into the third signal s3.

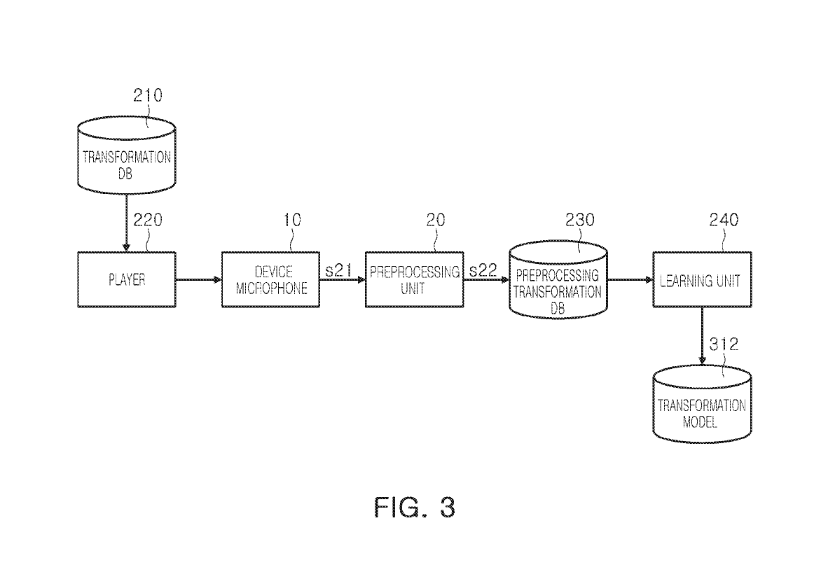

The transformation model 312 may be generated by machine learning such as deep learning. In detail, the transformation model may be generated by learning (training) a model via machine learning. A method of generating the transformation model 312 will be described below in detail with reference to FIG. 3.

The recognition portion 32 may apply the recognition model 322 to the third signal s3, to thus output a recognition result. The recognition result may be in the form of text.

The recognition engine 321 may extract a feature point associated with the third signal s3, apply the feature point to the recognition model 322, and output a recognition result based on the applied result.

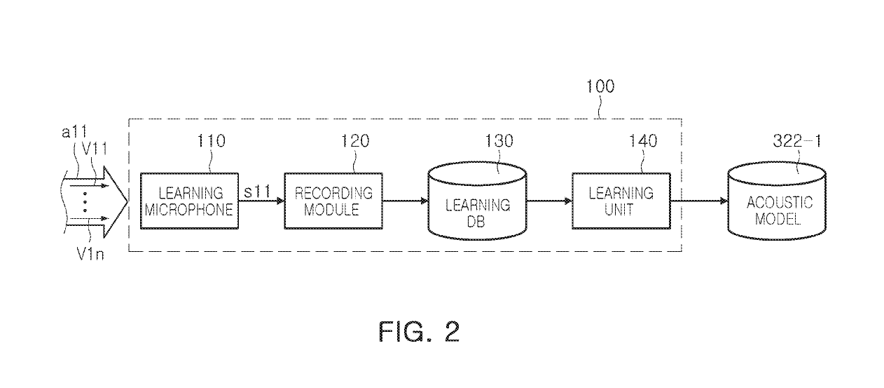

The recognition model 322 may be generated by machine learning such as deep learning. In detail, the recognition model may be generated by learning (training) a model via machine learning. Although not illustrated in the drawings, the recognition model 322 may include at least one of an acoustic model and a language model. The acoustic model and the language model may be respectively generated via machine learning such as deep learning. The acoustic model and the language model may be respectively generated by training any model via machine learning. The acoustic model may be used to determine a phoneme from the third signal s3, and the language model may be used to determine a language from the third signal s3. For example, the recognition engine 321 may extract a feature point associated with the third signal s3, apply the feature point to the acoustic model to determine a phoneme of the third signal s3, and then, re-apply the determination result to the language model, thereby determining a word or phrase of the third signal s3. A method of generating the recognition model 322 will be described below in detail with reference to FIG. 2.

The preprocessor 20, the conversion portion 31 of the speech recognition unit 30, and the recognition portion 32 of the speech recognition unit 30 may be implemented by one or more computing devices, including one or more processors. The computing device may include an application processor (AP) configured to be used in a mobile terminal or a variety of electronic devices. In addition, the computing device may include at least one processor (also referred to as at least one instance of “processing circuitry”) and a memory. In this case, the processor may include, for example, a central processing unit (CPU), a graphics processing unit (GPU), a microprocessor, an application specific integrated circuit (ASIC), field programmable gate arrays (FPGA), and the like. The memory (also referred to herein as a non-transitory computer readable storage medium) may include a volatile memory such as a random access memory (RAM) and the like, a nonvolatile memory such as a read-only memory (ROM), a flash memory and the like, or a combination thereof. Computer-readable commands (also referred to herein as one or more computer-executable programs of instruction) to implement example embodiments of the present inventive concepts may be stored in the memory.

In some example embodiments, the computing device may include an additional storage. An example of the storage may include a magnetic storage, an optical storage, and the like, but is not limited thereto. Computer-readable commands to implement example embodiments of the present inventive concepts may be stored in the storage, and other computer-readable commands to implement an operating system, an application program, and the like may also be stored therein. The computer-readable commands stored in the storage may be loaded into the memory to be executed by a processor.

In some example embodiments, the computing device may include a communications connection portion(s) enabling the computing device to communicate with other devices, for example, other computing devices. In this case, the communications connection portion(s) may include a modem, a network interface card, an integrated network interface, a radio frequency transmitter/receiver, an infrared port, a universal serial bus (USB), or other interfaces allowing a computing device to be connected to other computing devices. In addition, the communications connection portion(s) may include wired connection or wireless connection.

Respective constituent elements of the computing device may be connected to each other via a variety of interconnections using a bus and the like, for example, a peripheral component interconnect (PCI), a USB, a firmware (IEEE 1394), an optical bus structure, and the like, and may also be connected to each other by a network.

Although FIG. 1 illustrates example embodiments in which the speech recognition device includes a preprocessor, the preprocessor may also be omitted in some cases. In this case, the conversion portion 31 may convert the first signal s1 output from the device microphone 10 into a signal having signal characteristics similar to those of an audio signal used when learning a recognition model.

FIG. 2 is a drawing illustrating a process of learning a recognition model of a speech recognition device according to some example embodiments, in which a process of learning an acoustic model of the recognition model is schematically illustrated.

A device 100 configured to learn (“generate”) an acoustic model 322-1 may include a learning microphone 110, a recording module 120, a storage medium 130 storing a learning database (DB) therein, and a learning unit 140.

The learning microphone 110 may output a learning signal s11 corresponding to input speech (e.g., an input audio signal a11 that includes one or more signals v11 to vin generated by one or more respective speakers). Although not illustrated in the drawings, a module configured to perform a preprocessing operation may be included in the learning microphone 110 or may be additionally provided, separately from the learning microphone 110. For example, the learning signal s11 may be generated by performing a desired (or, alternatively predetermined) preprocessing operation on a signal output from the learning microphone 110.

The recording module 120 may generate a learning DB by recording the learning signal s11 and using the learning signal s11 corresponding to a variety of speech to build a database. The learning DB may be stored in the storage medium (e.g., non-transitory computer readable storage medium) 130. The learning DB may have a data size large enough to include signals corresponding to all speech generally utterable by people (e.g., audio signals generally generated by one or more speakers). For example, a relatively sufficient amount of audio signals may be stored in a database in such a manner that a generated acoustic model 322-1 may recognize speech uttered by various speakers (e.g., audio signals generated by various speakers) via various speaking methods in actual situations.

The learning unit 140 may generate the acoustic model 322-1 by extracting a feature of the learning DB and performing model training using the extracted learning DB characteristics. For example, when a plurality of learning audio signals with respect to a plurality of words or respective phrases are input, a model may be trained to output a word or a phrase corresponding thereto, thereby generating an acoustic model. As the learning method, machine learning such as deep learning may be used.

Although not illustrated in the drawings, a language model of the recognition model 322 may also be generated by the same method as the method of FIG. 2.

FIG. 3 is a drawing illustrating a process of learning a transformation model of a speech recognition device according to some example embodiments.

First, a transformation DB may be selected to be stored in a storage device (“memory”) 210. The transformation DB may include a set of audio files including signals corresponding to one or more audio signals. The transformation DB may have data to be able to reflect frequency characteristics of an audio signal, for example, relatively small data as compared with that of the learning DB. In addition, a signal of the transformation DB may have the same characteristics as that of the learning signal s11, an output signal from the learning microphone 110, used to learn the acoustic model 322-1 illustrated in FIG. 2. For example, the transformation DB may be generated by recording a plurality of signals corresponding to a plurality of words or phrases via the learning microphone 110 and the recording module 120, and may also be generated by selecting a portion of the learning DB.

Next, the audio files (e.g., signals) of the transformation DB may be played via a player 220 to generate one or more sets of audio signals.

The device microphone 10 may output a first conversion signal s21 corresponding to speech (e.g., voice audio signals) generated by the player 220.

The preprocessor 20 may receive the first conversion signal s21 and perform a preprocessing operation thereon to output a second conversion signal s22.

For example, after the audio file of the transformation DB is played via the player 220, the second conversion signal s22 may be generated using the device microphone 10 and the preprocessor 20 of the speech recognition device according to some example embodiments of the present inventive concepts. Then, the second conversion signal s22 with respect to all of audio files in the transformation DB may be stored in a database, to thus generate a preprocessing transformation DB and store the generated preprocessing transformation DB in a storage device 230.

A learning unit 240 may extract a characteristic of the preprocessing transformation DB and perform model training using the extracted preprocessing transformation DB characteristics, thereby generating a transformation model 312. For example, when an audio signal of the preprocessing transformation DB is input, a model may be trained to output an audio signal of the transformation DB and thus generate the transformation model. As the learning method, machine learning such as deep learning may be used.

Then, by using the transformation model 312 learned in the method described above, the audio signal generated via the device microphone 10 and the preprocessor 20 may be converted into an audio signal having signal characteristics similar to those of the audio signal the same as that used in learning the acoustic model 322-1 of the recognition model 322.

In addition, for example, when with respect to the audio signal converted using the transformation model 312, speech is recognized using the recognition model 322, recognition performance may be significantly improved as compared to the case in which the transformation model 312 is not used.

In addition, with respect to a variety of devices in which characteristics of audio signals used for speech recognition are different due to different types of microphones or preprocessors, when transformation models designed appropriately for respective types of devices are applied thereto, speech recognition operations may be performed using the same recognition model, for example, an acoustic model and a language model, in various devices.

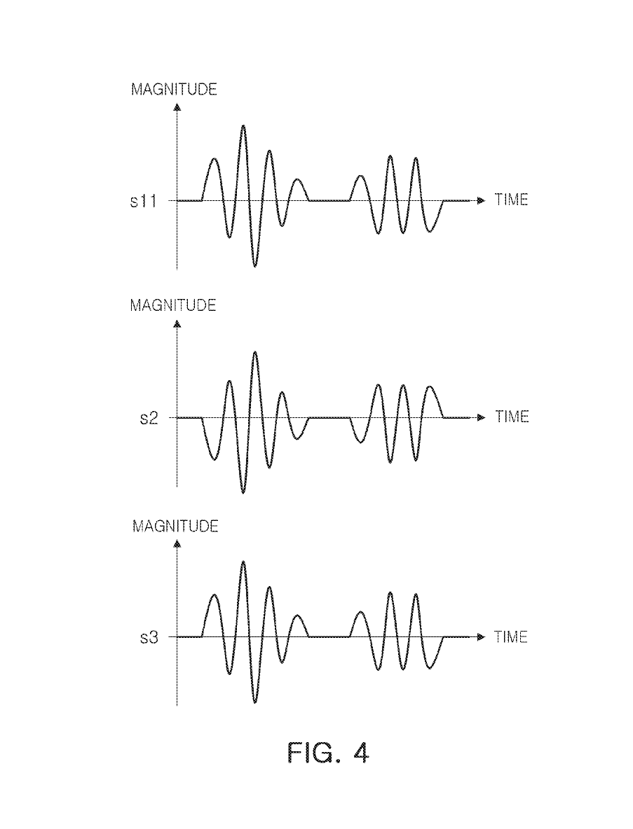

FIG. 4 is a drawing illustrating operations of a conversion portion of a speech recognition device according to some example embodiments. In FIG. 4, s11 indicates a learning signal output from the learning microphone 110 of FIG. 2 when an optional test word is input as a signal v11 included in an audio signal a11 to the learning microphone 110 of FIG. 2, s2 indicates a second signal output from the preprocessor 20 of FIG. 1 when the test word is input as a signal v1 included in an audio signal a1 to the device microphone 10 of FIGS. 1, and s3 indicates a third signal output from the conversion portion 31 of FIG. 1 when the test word is input as a signal v1 included in an audio signal a1 to the device microphone 10 of FIG. 1.

As described above, the recognition model, or an acoustic model of the recognition model, may be trained to output text with respect to a test word, as a recognition result, for example, when the learning signal s11 with respect to the test word is input (e.g., as signal v11).

In some example embodiments, a microphone, for example, the device microphone 10 of FIG. 1, used in an environment in which the recognition model, or the acoustic model of the recognition model, is actually used, is different from a microphone, for example, the learning microphone 110 of FIG. 2, used when learning the recognition model, or the acoustic model of the recognition model. In some example embodiments, the preprocessing operation, for example, an operation performed by the preprocessor 20 of FIG. 1, applied to an environment in which the recognition model, or an acoustic model of the recognition model, is different from a preprocessing operation performed in a device (for example, 100 of FIG. 2) used to learn a recognition model, or an acoustic model of the recognition model.

Therefore, for example, even when the same test words are input to the device microphone 10 (see FIG. 1), the second signal s2 output from the preprocessor 20 (FIG. 1) may be different from the learning signal s11 corresponding to the test words, and for example, may be a signal of which a phase has been inverted as illustrated in FIG. 4.

For example, when speech is recognized by applying a recognition model to the second signal s2, the speech recognition may not be performed normally.

According to some example embodiments, as illustrated in FIG. 4, the second signal s2 output from the preprocessor 20 may be converted into a signal that is the same as that used when learning the recognition model, for example, the third signal s3 having signal characteristics similar to those of the learning signal s11, by the conversion portion 31 (see FIG. 1).

Since the third signal s3 has similar characteristics to those of the learning signal s11, when the recognition model is applied to the third signal s3, the speech recognition performance may be improved.

In some example embodiments, for example, when speech recognition is performed in a plurality of devices having different types of microphones or preprocessing operations, even in the case that a recognition model or an acoustic model of the recognition model is not separately generated for each device, only when an appropriate transformation model is generated and used, a speech recognition function having improved performance may be implemented by using the same recognition model or an acoustic model of the recognition model in the plurality of devices.

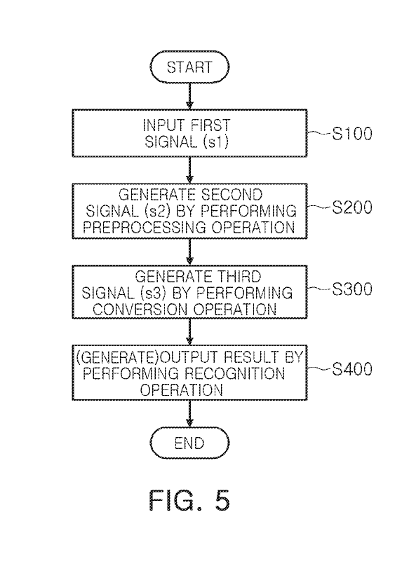

FIG. 5 is a flowchart illustrating operations of a speech recognition method according to some example embodiments.

First, a first signal s1 may be input in S100. The first signal s1 may be a signal generated from a microphone of a device, for example, the device microphone 10 (see FIG. 1), to which speech to be recognized is input as an audio signal a1 that may include one or more voice audio signals v1 to vn.

Next, a second signal s2 may be generated by performing a preprocessing operation on the first signal s1, in 5200. The preprocessing operation may be carried out by performing at least one of a variety of operations described with reference to FIG. 1.

Subsequently, the second signal s2 may be converted into a third signal s3 having signal characteristics similar to those of a signal that corresponds to the signal used in learning a recognition model, by performing a conversion operation, in S300. To perform the conversion operation, the transformation model generated using the method described with reference to FIG. 3 may be used.

Next, a recognition operation may be performed on the third signal s3, thereby outputting (“generating”) a recognition result, in S400. To perform the recognition operation, the recognition model, for example, an acoustic model and a language model, generated using the method described with reference to FIG. 2 may be used.

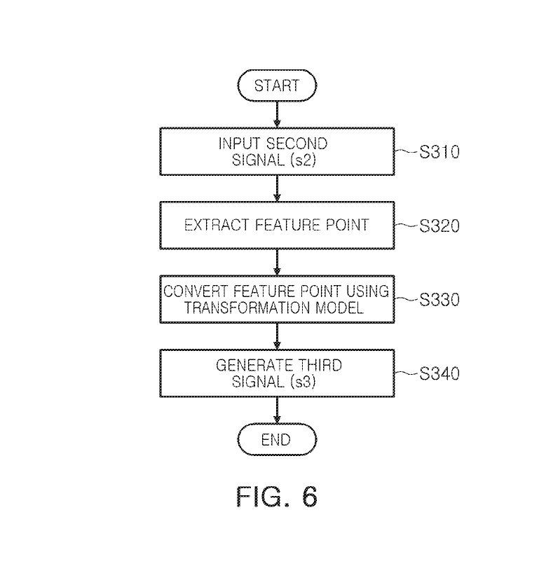

FIG. 6 is a flowchart illustrating transformation operations performed in the speech recognition method of FIG. 5. The operations shown in FIG. 6 may be performed as part of performing the conversion operation S300 as shown in FIG. 5.

First, the second signal s2 may be input in S310.

Next, a feature point associated with the second signal s2 may be extracted in S320. As described above, the feature point may be a value for a frequency characteristic or a phase of the second signal s2. For example, values for respective frequencies provided when the second audio signal is converted into a frequency domain may be the feature points associated with the second signal s2.

Next, the feature point may be converted using a transformation model in S330. For example, by performing processes of multiplying each of the plurality of feature points by a desired (or, alternatively predetermined) weight, adding or subtracting a desired (or, alternatively predetermined) offset thereto or therefrom, or the like, the feature point may be converted. The transformation model may be generated using the method described with reference to FIG. 3.

Next, the third signal s3 obtained by converting the feature point associated with the second signal s2 may be generated in S340. For example, when the feature point associated with the second signal s2 is converted using the transformation model, the third signal s3 may have signal characteristics similar to those of an audio signal, for example, the learning signal s11 of FIG. 2, the same as that used in learning the recognition model.

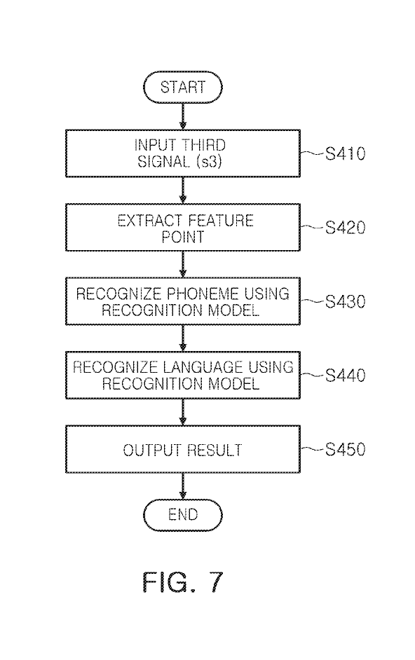

FIG. 7 is a flowchart illustrating recognition operations of the speech recognition method of FIG. 5. The operations shown in FIG. 7 may be performed as part of performing the recognition operation S400 as shown in FIG. 5.

First, the third signal s3 may be input in S410.

Next, a feature point associated with the third signal s3 may be extracted in S420.

Then, a phoneme of the third signal s3 may be recognized using an acoustic model of the recognition model in S430. For example, a feature point associated with the third signal s3 may be extracted, and a phoneme of the third audio signal may be determined by applying the feature point to the acoustic model. The acoustic model may be generated using the same method described with reference to FIG. 2. In addition, since the third signal s3 has signal characteristics similar to those of the learning signal s11 (see FIG. 2) the same as that used in learning the acoustic model, the speech recognition performance in S430 may be further improved.

Subsequently, a language, for example, words or phrases, may be recognized using a language model of the recognition model in S440. For example, the phonemes of the third signal s3 determined in S430 may be listed according to time, and then, may be applied to the language model to thus recognize a language.

Next, a recognition result may be output (“generated”) in S450. The recognition result may include information indicating a language having been recognized as corresponding to one or more voice audio signals v1 to vn in S440 in the form of text. For example, in S450, data indicating the language having been recognized as corresponding to voice audio signal v1 in S440 may be converted into text indicating the recognized language, and then, the converted text may be output as the recognition result.

The respective operations illustrated in FIGS. 5 to 7 may be performed by a computing device, such as an application processor (AP) and the like.

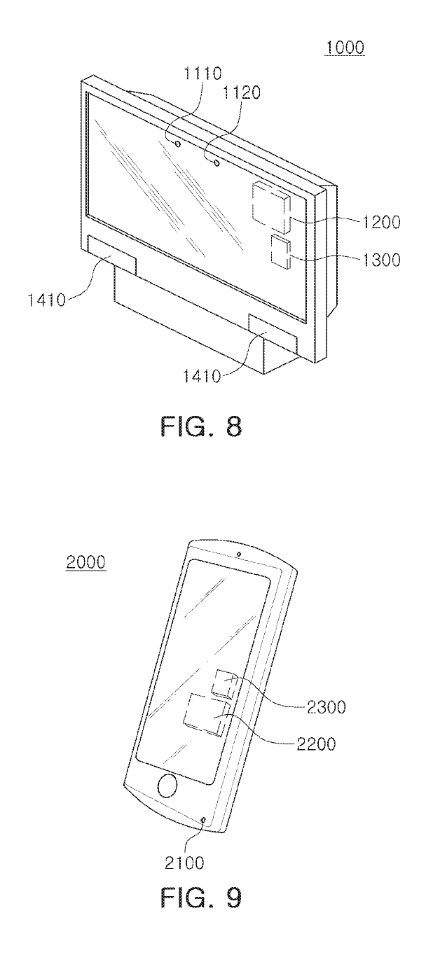

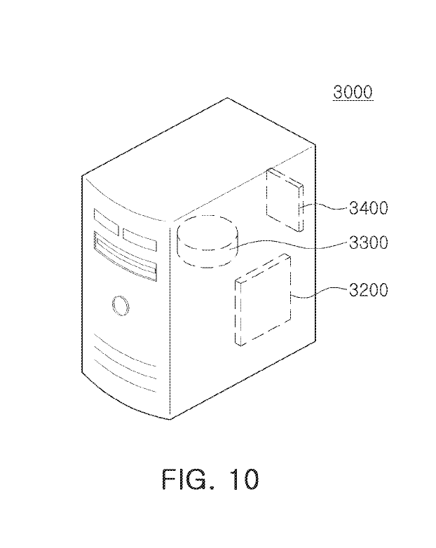

FIG. 8, FIG. 9, and FIG. 10 are schematic diagrams of apparatuses including a speech recognition device according to some example embodiments.

As illustrated in FIG. 8, a speech recognition device according to some example embodiments may be included in a smart TV.

A smart television (TV) 1000 may include microphones 1110 and 1120, an application processor 1200, a storage device 1300, and speakers 1410 and 1420.

The microphones 1110 and 1120 may output an audio signal corresponding to speech input. The microphones 1110 and 1120 may respectively perform desired (or, alternatively predetermined) preprocessing operations to output audio signals.

The application processor 1200 may convert signals, corresponding to one or more audio signals, input from the microphones 1110 and 1120 into conversion signals using a transformation model, recognize phonemes included in the conversion signals using a recognition model, and recognize words or phrases included in the audio signals on the basis of the recognized phonemes. Further, the application processor 1200 may control a signal corresponding to an audio signal generated at the smart television according to the recognized word or phrase. For example, the application processor 1200 may control the smart television to be turned off or on, may change a channel thereof, or may adjust the volume of sound output from the speakers 1410 and 1420. The application processor 1200 may perform recognition operations as described above in the same method described above with reference to FIG. 7. In addition, the application processor 1200 may also perform a desired (or, alternatively predetermined) preprocessing operation prior to the recognition operation described above.

The storage device 1300 may store a recognition program for a speech recognition method according to some example embodiments, a transformation model, and a recognition model. The recognition program may be loaded into the application processor 1200 for execution thereof.

According to some example embodiments, all or a portion of a program to perform a speech recognition method according to some example embodiments, a transformation model, and a recognition model may be stored in a memory included in the application processor 1200. For example, when the entirety of the program, the transformation model, and the recognition model are stored in the memory included in the application processor 1200, the storage device 1300 may be omitted.

The speakers 1410 and 1420 may output a desired (or, alternatively predetermined) sound (e.g., audio signal). As described above, the speakers 1410 and 1420 may be controlled by the application processor 1200.

Although FIG. 8 illustrates the smart television as the device according to some example embodiments of the present inventive concepts, the speech recognition device according to some example embodiments may be included in any device requiring speech recognition, such as a piece of medical equipment, an industrial device, or the like, as well as a variety of home appliances such as a refrigerator, an air conditioner, and the like.

As illustrated in FIG. 9, a speech recognition device according to some example embodiments may be included in mobile terminals such as smartphones.

A mobile terminal 2000 may include a microphone 2100, an application processor 2200, and a storage device 2300.

The microphone 2100 may output an audio signal corresponding to speech input thereto. The microphone 2100 may perform a desired (or, alternatively predetermined) preprocessing operation to output an audio signal.

The application processor 2200 may convert a signal corresponding to an audio signal input from the microphone 2100 into an conversion signal using a transformation model, may recognize a phoneme included in the conversion signal using a recognition model, and may recognize a word or a phrase on the basis of the recognized phoneme. Further, the application processor 2200 may control various functions according to the recognized word or phrase. For example, the application processor 2200 may search a telephone number or the like, matched to a recognized word or the like, from a contacts file, and display the searched result, or may display a result retrieved through the Internet or the like with respect to information related to the recognized word. The application processor 2200 may perform the recognition operations as described above in the same method described above with reference to FIGS. 5 to 7. In addition, the application processor 2200 may also perform a desired (or, alternatively predetermined) preprocessing operation prior to a recognition operation as described above.

The storage device 2300 may store a recognition program for a speech recognition method according to some example embodiments, a transformation model, and a recognition model. The recognition program may be loaded into the application processor 2200 for execution thereof.

According to some example embodiments, the entirety or a portion of the program to perform a speech recognition method according to some example embodiments, the transformation model, and the recognition model may be stored in a memory included in the application processor 2200. For example, when the entirety of the program to perform a speech recognition method, the transformation model, and the recognition model are stored in the memory included in the application processor 2200, the storage device 2300 may be omitted.

As illustrated in FIG. 10, a speech recognition device according to some example embodiments may be included in a server.

The server 3000 may include at least one central processor 3200, a storage device 3300, and a communications interface 3400.

The communications interface 3400 may receive a signal corresponding to an audio signal from a mobile terminal such as smartphones and the like, or other devices requiring speech recognition in a wired or wireless manner, and may transmit a result recognized by the central processor 3200 to the devices.

The central processor 3200 may convert the signal, having been received by the communications interface 3400, into a conversion signal, using a transformation model, recognize a phoneme included in the conversion signal using a recognition model, recognize a word or a phrase of the audio signal on the basis of the recognized phoneme, and output the recognized result. The central processor 3200 may perform the recognition operations in the same method described above with reference to FIGS. 5 to 7. In addition, the central processor 3200 may also perform a desired (or, alternatively predetermined) preprocessing operation prior to a recognition operation as described above.

The storage device 3300 may store a recognition program for a speech recognition method according to some example embodiments, a transformation model, and a recognition model. The recognition program may be loaded into the central processor 3200 for execution thereof.

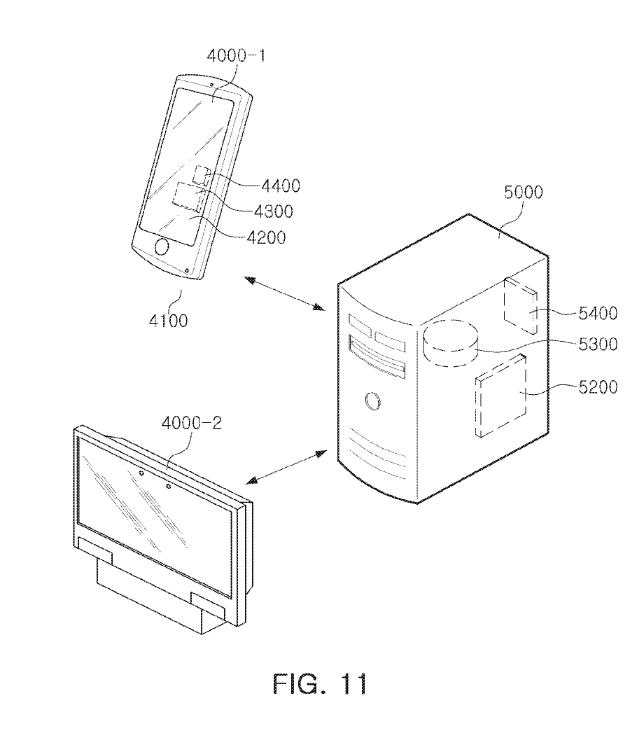

FIG. 11 is a schematic diagram illustrating a system in which a speech recognition method according to some example embodiments is performed.

A plurality of devices 4000-1 and 4000-2 may respectively be a mobile terminal or a device requiring speech recognition. As illustrated in FIG. 11, the device 4000-1 may be a mobile terminal, and the device 4000-2 may be a home appliance such as a smart TV or the like. Although not illustrated in the drawing, the plurality of devices 4000-1 and 4000-2 may be different types of mobile terminals, and may also be a variety of consumer electronic devices. Each of the plurality of devices 4000-1 and 4000-2 may include a microphone 4100, an application processor 4200, a storage device 4300, and a communications interface 4400.

The microphone 4100 may output a signal corresponding to an audio signal, where the audio signal includes at least one voice audio signal corresponding to speech generated by a speaker.

The application processor 4200 may perform a desired (or, alternatively predetermined) preprocessing operation on the signal.

The storage device 4300 may store a program for a preprocessing operation therein. The program may be loaded into the application processor 4200 for execution thereof. The storage device 4300 may be omitted in some cases.

The communications interface 4400 may transmit a preprocessed signal to a server 500, and may receive a recognition result from the server 5000. The communications interface 4400 may be connected to the server 5000 in a wired or wireless manner.

The preprocessing operation may also be performed by the microphone 4100. For example, the preprocessing operation may only be performed in the microphone 4100, or may only be performed in the application processor 4200. In some example embodiments, a portion of the preprocessing operation may be performed by the microphone 4100 and a remaining portion thereof may be performed by the application processor 4200.

The server 5000 may include at least one central processing unit 5200, a storage device 5300, and a communications interface 5400.

The communications interface 5400 may receive an audio signal from a mobile terminal such as smartphones and the like, or other devices requiring speech recognition in a wired or wireless manner, and may transmit a result recognized by the central processing unit 5200 to the devices.

The central processing unit 5200 may select a transformation model appropriate for the device to which the signal has been transmitted, convert the audio signal having been received by the communications interface 5400 into a conversion signal using the selected transformation model, recognize a phoneme included in the conversion signal using a recognition model, recognize a word or a phrase of the voice audio signal included in the audio signal to which the signal corresponds on the basis of the recognized phoneme, and output a recognized result. The central processing unit 5200 may perform the recognition operations in the same method as described above with reference to FIGS. 5 to 7. In addition, the central processing unit 5200 may also perform a desired (or, alternatively predetermined) preprocessing operation prior to the recognition operation as described above.

The storage device 5300 may store a recognition program for a speech recognition method according to some example embodiments, a transformation model, and a recognition model. The recognition program may be loaded into the central processing unit 5200 for execution thereof.

According to example embodiments, the application processor 4200 of each of the plurality of devices 4000-1 and 4000-2 may convert the preprocessed audio signal into an conversion signal using a transformation model to transform the signal. In this case, the transformation model may also be stored in the storage device 4300 of each of the plurality of devices 4000-1 and 4000-2, and may also be stored in a memory included in the application processor 4200.

In this case, the server 5000 may output a result obtained by recognizing the conversion signal.

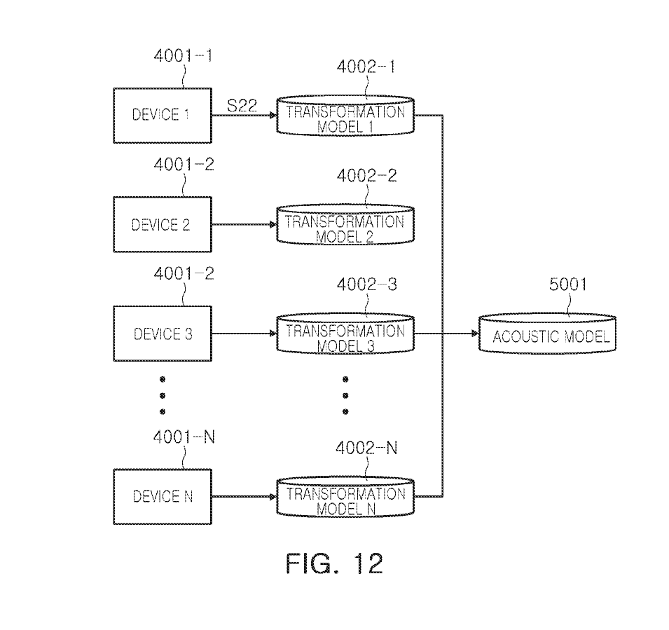

FIG. 12 is a view conceptually illustrating a method of applying a speech recognition method according to some example embodiments to a variety of devices.

As illustrated in FIG. 12, in a speech recognition method according to some example embodiments, transformation models appropriate for a plurality of respective devices 4001-1, 4001-2, 4001-3, . . . , and 4001-N may be generated. By using the appropriate transformation models 4002-1, 4002-2, 4002-3, . . . , and 4002-N, for example, even when a single acoustic model 5001 is used, excellent speech recognition performance may be secured.

As set forth above, in a speech recognition method, a speech recognition device, an apparatus including a speech recognition device according to example embodiments, speech may be more effectively recognized. In some example embodiments, the same acoustic model may be commonly used in a variety of devices, or even in the case that a preprocessing technique or a device microphone changes, an existing acoustic model may be used, to thus shorten development time of the speech recognition device. Speech recognition performance may also be significantly secured according to various types of devices.

While example embodiments have been shown and described above, it will be apparent to those skilled in the art that modifications and variations could be made without departing from the scope of the present disclosure as defined by the appended claims.

1. A method, comprising:
performing a preprocessing operation on a first signal to generate a second signal, the first signal corresponding to an audio signal that includes at least one voice audio signal generated by a speaker;
extracting a feature point associated with the second signal;
converting the second signal into a third signal based on converting the feature point using a transformation model;
applying a recognition model to the third signal to recognize a voice language corresponding to the at least one voice audio signal; and
generating a recognition result output including information indicating the recognized language.

2. The method of claim 1, wherein the feature point associated with the second signal includes information indicating a magnitude of a frequency of the second signal.

3. The method of claim 1, wherein the feature point is converted based on performing one of,
multiplying the feature point by a particular weight value,
adding a particular offset value to the feature point, or
subtracting the particular offset value from the feature point.

4. The method of claim 1, wherein,
the recognition model includes an acoustic model and a language model; and
the generating includes recognizing a phoneme associated with the third signal based on,
applying the acoustic model to the third signal, and
recognizing the language corresponding to the voice audio signal according to the phoneme and the language model.

5. The method of claim 4, wherein,
the first signal is generated by a microphone, and
the transformation model is generated based on,
generating one or more audio signals having substantially common signal characteristics as one or more signal characteristics of a speech learning signal associated with the acoustic model,
generating a first conversion signal corresponding to one or more voice audio signals included in the one or more audio signals,
generating a preprocessing transformation database based on performing the preprocessing operation on the first conversion signal, and
performing model training according to the preprocessing transformation database to generate the transformation model.

6. The method of claim 4, wherein,
the acoustic model is generated based on performing model training according to a learning database in which a variety of audio signals are stored,
the first signal is generated by a microphone, and
the transformation model is generated based on,
generating a limited selection of the audio signals stored in the learning database,
generating a first conversion signal corresponding to one or more voice audio signals included in the limited selection of the audio signals,
generating a preprocessing transformation database based on performing the preprocessing operation on the first conversion signal, and
performing model training according to the preprocessing transformation database to generate the transformation model.

7-22. (canceled)

23. A method, comprising:
playing a transformation database audio signal having signal characteristics that are substantially common with signal characteristics of a speech learning signal associated with a recognition model;
generating a first conversion signal corresponding to one or more voice audio signals included in the transformation database audio signal;
generating a preprocessing transformation database based on performing a preprocessing operation on the first conversion signal; and
performing model training according to the preprocessing transformation database to generate a transformation model.

24. The method of claim 23, wherein,
the recognition model is generated based on performing model training according to a learning database including the speech learning signal, and
the transformation database audio signal is a signal selected from a plurality of signals stored in the learning database.

25. The method of claim 23, further comprising:
performing a preprocessing operation on a first signal to generate a second signal, the first signal corresponding to an audio signal that includes at least one voice audio signal generated by a speaker;
extracting a feature point associated with the second signal;
converting the second signal into a third signal based on converting the feature point using the transformation model;
applying a recognition model to the third signal to recognize a voice language corresponding to the at least one voice audio signal; and
generating a recognition result output including information indicating the recognized language.

26. The method of claim 25, wherein the feature point associated with the second signal includes information indicating a magnitude of a frequency of the second signal.

27. The method of claim 25, wherein the feature point is converted based on performing one of,
multiplying the feature point by a particular weight value,
adding a particular offset value to the feature point, or
subtracting the particular offset value from the feature point.

28. The method of claim 25, wherein,
the recognition model includes an acoustic model and a language model; and
the generating the recognition result output includes recognizing a phoneme associated with the third signal based on,
applying the acoustic model to the third signal, and
recognizing the language corresponding to the voice audio signal according to the phoneme and the language model.

29. A method, comprising:
extracting, from a signal, a feature point associated with the signal, the signal corresponding to an audio signal that includes at least one voice audio signal generated by a speaker;
converting the signal based on converting the feature point using a transformation model;
applying a recognition model to the converted signal to recognize a voice language corresponding to the at least one voice audio signal; and
generating a recognition result output including information indicating the recognized language.

30. The method of claim 29, wherein the feature point includes information indicating a magnitude of a frequency of the signal.

31. The method of claim 29, wherein the feature point is converted based on performing one of,
multiplying the feature point by a particular weight value,
adding a particular offset value to the feature point, or
subtracting the particular offset value from the feature point.

32. The method of claim 29, wherein,
the recognition model includes an acoustic model and a language model; and
the generating includes recognizing a phoneme associated with the converted signal based on,
applying the acoustic model to the converted signal, and
recognizing the language corresponding to the voice audio signal according to the phoneme and the language model.

33. The method of claim 29, further comprising
generating the signal based on performing a preprocessing operation on a received signal, the received signal corresponding to the audio signal.

34. The method of claim 33, wherein,
the recognition model includes an acoustic model and a language model; and
the generating includes recognizing a phoneme associated with the converted signal based on,
applying the acoustic model to the converted signal, and
recognizing the language corresponding to the voice audio signal according to the phoneme and the language model.

35. The method of claim 34, wherein,
the received signal is generated by a microphone, and
the transformation model is generated based on,
generating one or more audio signals having substantially common signal characteristics as one or more signal characteristics of a speech learning signal associated with the acoustic model,
generating a first conversion signal corresponding to one or more voice audio signals included in the one or more audio signals,
generating a preprocessing transformation database based on performing the preprocessing operation on the first conversion signal, and
performing model training according to the preprocessing transformation database to generate the transformation model.

36. The method of claim 34, wherein,
the acoustic model is generated based on performing model training according to a learning database in which a variety of audio signals are stored,
the signal is generated by a microphone, and
the transformation model is generated based on,
generating a limited selection of the audio signals stored in the learning database,
generating a first conversion signal corresponding to one or more voice audio signals included in the limited selection of the audio signals,
generating a preprocessing transformation database based on performing the preprocessing operation on the first conversion signal, and
performing model training according to the preprocessing transformation database to generate the transformation model.
